(19) United States
(12) Patent Application Publication
(10) Pub. No.: US 2006/0286243 A1
(43) Pub. Date: Dec. 21, 2006

(54) Protein desserts

(76) Inventor: Jennifer A. Madrid, Wylie, TX (US)

Correspondence Address: JAMES RAY & ASSOCIATES, 2640 PITCAIRN ROAD, MONROEVILLE, PA, 15146, US

(21) Appl. No.: 11/448,644

(22) Filed: Jun. 7, 2006

Related U.S. Application Data
(60) Provisional application No. 60/688,152, filed on Jun. 7, 2005.

(51) Int. Cl. A21D 10/00; A23G 9/00

(52) U.S. Cl. 426/549; 426/565

(57) ABSTRACT

A protein supplemented dessert product that essentially consists of at least one of a predetermined amount of a preselected dessert product. There is also at least one of Whey and soy product added in a predetermined amount to the at least one of such preselected dessert product. The preselected dessert product also contains a preselected flavoring.

### CROSS REFERENCE TO RELATED APPLICATIONS

This application is closely related to and claims benefit from U.S. Provisional Application Ser. No. 60/688,152 filed Jun. 07, 2005.

### FIELD OF THE INVENTION

The present invention relates, in general, to desserts, and, more particularly, the present invention relates to high protein, low fat, low carbohydrate desserts and low sugar.

### BACKGROUND OF THE INVENTION

It is not always easy for people to receive the recommended daily allowance of protein. This is particularly true for persons that are vegetarians, vegans, the elderly and children, particularly children who are picky eaters. Many of these people have a difficult time getting enough protein to maintain a healthy lifestyle.

Athletes, sportsmen and others concerned with health and fitness love high protein snacks but the benefits are often offset by the bland taste of many of these desserts and also because of the high amounts of sugar, sodium or fat that are also present in these desserts. It seems that everything good for you is always trade off.

Thus, it would be advantageous if there were a dessert type product that provided sufficient protein and still did not contain large quantities of sugar, carbohydrate, sodium or fat and still was enjoyable to eat.

### SUMMARY OF THE INVENTION

In a first aspect the present invention provides a protein supplemented dessert product. The dessert product essentially consists of a predetermined amount of a preselected dessert product along with at least one of whey and soy product added in a predetermined amount to the at least one of such preselected dessert product. The preselected dessert product also contains a preselected flavoring.

In another aspect of the invention there is provided a method of preparing a protein supplemented dessert. Such method comprises the steps of selecting a predetermined dessert and a step of determining a number of servings required for the predetermined dessert selected in the previous step. This is followed by a step of placing all the ingredients necessary for such predetermined dessert selected in a previous step in an amount sufficient to produce the number of servings determined in the previous step into a mixing container. There is a step of adding a predetermined amount of one of Whey and soy protein to the ingredients placed into such mixing container in the previous step so that each serving from the predetermined dessert will contain substantially 20 grams of protein that is derivable from such one of whey and soy protein. Such method includes a step of adding a preselected flavoring to the ingredients from the previous step and a step of blending these ingredients for such predetermined dessert with the predetermined amount of one of such whey and soy protein included therein and the step of placing the blended product into a suitable container.

### OBJECTS OF THE INVENTION

It is, therefore, one of the primary objects of the present invention to provide a healthful dessert that contains a high level of protein.

Another object of the present invention is to provide a healthful dessert that is tasteful as well as healthful.

Still another object of the present invention is to provide healthful dessert that is low fat and low carb.

Yet another object of the present invention is to provide a healthful dessert that is easy to prepare.

These and various other objects and advantages of this invention will become apparent after a full reading of the following detailed description, particularly, when read in conjunction with the attached drawings as described below and the appended claims.

### BRIEF DESCRIPTION OF THE PRESENTLY PREFERRED AND ALTERNATE EMBODIMENTS OF THE INVENTION

The present invention provides a variety of desserts which were created as an enjoyable way to supply a person's body with the healthful benefits of protein it needs in the form of tasty desserts. These desserts are an exciting and convenient alternative to the foods which many children refuse to eat, foods vegetarians cannot eat and the high in fat desserts which many of us eat.

In a first aspect the present invention provides a protein supplemented dessert product. The dessert product essentially consists of a predetermined amount of a preselected dessert product along with at least one of whey and soy product added in a predetermined amount to the at least one of such preselected dessert product. The preselected dessert product also contains a preselected flavoring.

Such preselected dessert is selected from at least one of pudding, yogurt, popsicle, ice cream, brownie and cake. It is, further, part of the invention that such flavoring and such preselected dessert product are selected from regular, low fat, low carb and sugar free products. The use of low fat or fat free milk or soy milk with sugar free ingredients in desserts such as puddings makes the dessert even more healthful.

Since popsicles are essentially Kool aid that is frozen, thus, Kool aid may be listed as a dessert since it would be the precursor of such popsicle dessert and becomes a dessert after it is frozen. However, such popsicles could be made with a mix other than Kool aid.

The flavoring for such protein supplemented dessert products is selected from chocolate, strawberry, vanilla, banana cream, peanut butter, cherry, lime, orange, lemon and butterscotch. Although these flavorings are listed since they include most of the common flavors it does not preclude the use of other flavorings if desired.

It is within the concept of the invention that the ingredients for such desserts as pudding, cakes or brownies can be from box mixes that can be purchased at supermarkets or such ingredients can be from a user's recipe where the ingredients are mixed from scratch. It doesn't matter where the ingredients originate the important part of the invention is the addition of Whey or soy product so as to provide the enhanced protein to the dessert.

Also such dessert as ice cream can be made from scratch in an ice cream maker or the ice cream could be already prepared and then blended to incorporate the Whey or soy and then placed back in the freezer to keep it frozen until ready for consumption. As is evident it is much easier to prepare ice cream desserts with the supplement where the ice cream is made in the ice cream maker. Also such pudding can be a dessert as refrigerated pudding or the pudding could be frozen and served as a frozen dessert.

In another aspect of the invention there is provided a method of preparing a protein supplemented dessert. Such method comprises the steps of selecting a predetermined dessert and a step of determining a number of servings required from the recipe for the predetermined dessert selected in the previous step. This is followed by a step of placing all the ingredients necessary for such predetermined dessert selected in a previous step in an amount sufficient to produce the number of servings determined in the previous step into a mixing container. There is a step of adding a predetermined amount of one of Whey and soy protein to the ingredients placed into such mixing container in the previous step so that each serving from the predetermined dessert will contain substantially 20 grams of protein that is derivable from such one of whey and soy protein. Such method includes a step of adding a preselected flavoring to the ingredients from the previous step and a step of blending these ingredients for such predetermined dessert with the predetermined amount of one of such whey and soy protein included therein and the step of placing the blended product into a suitable container.

Such predetermined dessert is selected from one of frozen or refrigerated pudding, frozen yogurt (or refrigerated yogurt), frozen popsicle, ice cream, brownie and cake. The flavorings are the same as previously listed.

The suitable container listed in the steps will be determined by the predetermined dessert that was selected. That is, if the dessert selected is a brownie mix or a cake mix then such suitable container would be a baking pan or a baking tray since these desserts would require baking in the oven. Whereas, if the dessert a popsicle which is made from Kool Aid which is to be frozen then a popsicle form would be a suitable container. Where the dessert is a frozen pudding, frozen yogurt or ice cream then the suitable container would be a container that could be put in the freezer. If the pudding and yogurt are to be refrigerated and not frozen then a different container would be suitable.

The amount of Whey or Soy product that is added would be dependent upon the number of servings that such recipe will provide. The method includes the step of adding about 29 grams of at least one of the whey and/or soy product to the ingredients for each serving that had been determined from the recipe for the predetermined dessert. This insures that each serving will contain substantially 20 grams of protein from the Whey or soy product that was added. There could be more protein per serving than 20 grams if there is some protein that is derivable from the ingredients of the predetermined dessert.

The Whey that will be added to the desserts consists essentially of Whey Protein Isolate, Protein Concentrate, Hydrolyzed Whey Peptides Natural and Artificial Flavor, Lecithin, salt, Acesulfame Potassium, Cellulose Gum and Xanthan Gum. Such Whey will be mixed with soybean and milk (soy milk and fat free milk).

The desserts made with Whey will derive the following from the Whey:

Calories 130, calories from fat 2.5 g, Saturated fat 1.5 g, Trans fat 0 g., Cholesterol 70 mg, sodium 130 mg, Total Carbs 5 g, sugar 2 g and Protein 20 g.

The soy products that are added to the desserts consist of Soy Protein Isolate, Crystalline Fructose, natural and artificial flavors and soybean. The soy products are especially useful for people who have lactose intolerance.

The desserts made with Soy Products will derive the following from The soy product:

Calories 160, Calories from fat 10 g, Total fat 1.5 g, Saturated fat 0 g, Cholesterol 0 g, Sodium 180 mg, Total Carbs 19 g, Dietary fiber less than 1 g, sugar 17 g and Protein 20 g.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A protein supplemented dessert product, said dessert product essentially consisting of:
(a) a predetermined amount of at least one of a preselected dessert product;
(b) at least one of whey and soy product added in a predetermined amount to said at predetermine amount of said least one of said preselected dessert product; and
(c) a preselected flavoring.

2. The protein supplemented dessert product, according to claim 1, wherein said at least one said preselected dessert product is selected from at least one of pudding, yogurt, popsicle, ice cream, brownie and cake.

3. The protein supplemented dessert product, according to claim 2, wherein said at least one of said pudding, said yogurt, said popsicle, said ice cream, said brownie and said cake are selected from at least one of regular, low fat, low carb and sugar free products.

4. The protein supplemented dessert product, according to claim 1, wherein said flavoring is selected from at least one of regular, low fat, low carb and sugar free products.

5. The protein supplemented dessert product, according to claim 1, wherein said flavoring is selected from chocolate, strawberry, vanilla, banana cream, peanut butter, cherry, lime, orange, lemon and butterscotch.

6. The protein supplemented dessert product, according to claim 2, wherein ingredients for said pudding, said cake and said brownie are selected from one of a prepared box mix and from a user's recipe.

7. The protein supplemented dessert product, according to claim 2, wherein said popsicle is prepared using a Kool aid mix and subsequently freezing said Kool aid.

8. A method of preparing protein supplemented dessert, said method comprising the steps of:
(a) selecting a predetermined dessert;
(b) determining a number of servings required for said predetermined dessert selected in step (a);
(c) placing ingredients for said preselected dessert selected in step (a) in an amount sufficient to produce said number of servings determined in step (b) into a mixing container;
(d) adding a predetermined amount of one of whey and soy protein to said ingredients placed into said mixing container in step (c) so that each serving will contain generally about 20 grams of protein derivable from said one of whey and soy protein;
(e) adding a preselected flavoring to said ingredients from step(d);
(f) blending said ingredients for said predetermined dessert with said predetermined amount of one of said whey and soy protein contained therein; and
(g) placing said blended product into a suitable container.

9. The method, according to claim 8, wherein said method further includes a step of selecting said predetermined dessert from one of pudding, yogurt, popsicle, ice cream, brownie and cake.

10. The method, according to claim 9, wherein said method includes a step of selecting one of a baking pan and a baking tray as said suitable container for use with a prepared mix for said brownie and said cake.

11. The method, according to claim 10, wherein said method includes a step of selecting ingredients from one of a prepared box mix and from a user's recipe for said prepared mix for said cake and said brownie.

12. The method, according to claim 9, wherein said method includes a step of selecting a popsicle form for making said popsicle from a kool aid mix.

13. The method, according to claim 8, wherein said method further includes a step of selecting a freezer container as said suitable container for one of said pudding and said ice cream.

14. The method, according to claim 8, wherein said method further includes the step of adding about 29 grams of at least one of said whey and said soy product to said ingredients obtained in step (c) for providing about 20 grams of protein for each serving determined in step (b).

15. The method, according to claim 9, wherein said method further includes the step of selecting said at least one of said pudding, said yogurt, said popsicle, said ice cream, said brownie and said cake from at least one of regular, low fat, low carb and sugar free products.

16. The method, according to claim 8, wherein said method further includes the step of selecting said flavoring from at least one of regular, low fat, low carb and sugar free products.
